(19) United States
(12) Patent Application Publication
(10) Pub. No.: US 2006/0032395 A1
(43) Pub. Date: Feb. 16, 2006

(54) Driveway, driveway module, and method for the production thereof

(76) Inventors: Johann Matuschek, Kerken (DE); Thomas Stihl, Luenen (DE); Franz-Xaver Pichlmeier, Taufkirchen (DE); Karl Fichtner, Muenchen (DE); Karl Kirstein, Kissing (DE); Wolfgang Kirstein, Diedorf (DE)

Correspondence Address: Striker Striker & Stenby, 103 East Neck Road, Huntington, NY, 11743, US

(21) Appl. No.: 10/517,354

(22) PCT Filed: May 23, 2003
(86) PCT No.: PCT/DE03/01697

§ 371 Date: Jul. 28, 2005

(30) Foreign Application Priority Data
May 28, 2002 (DE) 102 24 148.1
Jul. 15, 2002 (DE) 202 10 808.2

(51) Int. Cl. B60L 13/00

(52) U.S. Cl. 104/286

(57) ABSTRACT

Disclosed is a module (10) for the driveway of a magnetically levitated vehicle. Said module (10) comprises functional surfaces (17, 18, 19) in the form of at least one laterally guiding assembly surface, one gliding assembly surface, and one stator pack assembly surface. The functional surfaces (17, 18, 19) are embodied on oversized pieces of equipment (14, 15, 16) which are made of steel, are connected in a fixed manner to the module (10), and are machined down in a cutting manner to a predefined set point dimension. Also disclosed are a driveway which comprises such modules and a method for producing said modules (10). The inventive method includes a step in which the modules are twisted in an elastic manner prior to being fixed to the beams in order to create changes in the lateral inclination.

The present invention relates to a driveway and a driveway module for magnetically levitated vehicles according to the definition of the species of Claims 1 and 18, and a method for the production of the driveway module.

Driveways with two types of functional surfaces are required for the propulsion and track guidance of magnetically levitated vehicles with longitudinal stator linear motors. At least one first functional surface in the form of a laterally guiding surface, which is fixed to a first piece of equipment in the form of a laterally guiding rail, is used for track guidance. At least one further first functional surface in the form of a gliding surface is required for normal stopping or emergency shutdown of the magnetically levitated vehicles, and is configured on a further first piece of equipment in the form of a slide rail. Finally, second functional surfaces in the form of mounting surfaces, which are used to subsequently install stator cores of the longitudinal stator linear motors, are configured on second pieces of equipment in the form of stator carriers. When the vehicles are in the levitating and driving state, there is a gap of approximately 10 mm between the undersides of these stator cores and bearing and excitation magnets mounted on the magnetically levitated vehicles.

The vehicles for magnetically levitated systems of this type which have been made known so far are composed primarily of driveway segments which are 24 m to 62 m long, for example, and are arranged one behind the other in the direction of a predefined track. Each driveway segment is composed of a carrier, which is supported on two or three supports, and the pieces of equipment fixed to said carrier. The first functional surfaces, i.e., the laterally guiding and gliding surfaces, should extend across the entire length of the carrier and be provided with all the bends necessary to travel through the curves, summits and valleys, etc. of the selected track. In contrast, the second functional surfaces, i.e., the mounting surfaces, are usually composed of flat surface segments separated from each other in the direction of the track, since the stator cores fixed to them are connected with the carrier only at selected points and are located such that their undersides—which are also flat—extend longitudinally along a polygon outline which approximates a predefined space curve (DE 199 34 912 A1).

The stated functional surfaces must be produced and/or installed with high precision to ensure flawless functioning of the guidance and drive system, even at driving speeds of up to 500 km/h and more. For the track width, which is established by the distance between at least two laterally guiding rails at the most, and the dimension of the binding piece established by the distance of the gliding surfaces from the undersides of the stator cores, dimensional tolerances of a maximum of 2 mm and preferably less than 1 mm—as viewed along the length of a carrier—are required, for example. In fact, tolerances of a maximum of 0.2 mm are permitted for the lateral and level displacement at the junctions of adjacent carriers and stator cores.

Numerous proposals have been made known for the production of functional surfaces and for the installation of pieces of equipment to the carriers.

The production of mounting surfaces for the stator cores is carried out entirely by, in a first step, fixing the stator carriers via welding or screwing to carriers made of steel, or by using grouting compound on concrete carriers. In a second step, the mounting surfaces are made by providing the stator carriers with bore holes for fastening screws and recesses suitable for accommodating spacer tubes, or they are first produced in oversized dimensions and then machined down in a cutting manner to a predefined setpoint dimension. In both cases, by using computer-aided tools and with consideration for all necessary track-related data, it is ensured that, after installation of the stator cores, their undersides are automatically positioned and oriented with the necessary tolerances (e.g., DE 34 04 061 C1, DE 39 28 277 C1).

The use of a method of this type is practical only for the installation of relatively short (maximum approximately 2 m long), linear stator cores, which can be produced in large quantities with identical dimensions and with very low tolerance deviations. On the other hand, transferring this method to the installation of relatively long, laterally guiding rails and slide rails having different bends depending on the track course would result in unjustifiably high costs. Aside from this, if the first pieces of equipment were installed in this manner, it would not be automatically ensured that the functional surfaces provided thereon would lie within the required tolerances along the entire length of the carrier.

When steel carriers are used, the laterally guiding rails and slide rails, which are usually made of steel, are therefore usually installed by fixing these pieces of equipment to the carriers in a manner analogous to that used with the stator carriers, via welding or with the aid of adjustable screws. To maintain the required tolerances along the entire length of the carrier, laborious adjustment work is therefore carried out to appropriately align the laterally guiding and sliding surfaces already present on the first pieces of equipment with the track and to compensate for any unevenness that may be present. The same applies for fixing these pieces of equipment to concrete supports with the aid of connecting bodies for fastening screws cast therein, or with the aid of anchors installed in the first pieces of equipment, the anchors being fixed—after having been positioned exactly—with grouting compound in recesses in the concrete supports provided therefore (e.g., ZEV-Glas. Ann. 105, 1981, pp. 205 through 215; “Bauingenieur” [Civil Engineer] 63, 1988, pp. 463 through 469). In addition, when concrete supports are used, it is known to produce the slide rails out of concrete and in an integral manner with the concrete supports, and to then grind them down to a predefined setpoint height oriented with the undersides of the stator cores. The stator cores must have been installed already, however. For carriers that have already been installed, the grinding process is therefore carried out with the aid of a special milling vehicle, which does not exactly simplify the production of the slide rails (“Magnetbahn Transrapid—Die neue Dimension des Reisens” [“Transrapid Magnetic Levitation Guideway—The New Dimension in Travel”] by Dr. Klaus Heinrich and Rolf Kretschmar, Hestra Verlag, Darmstadt, 1989, p. 23).

It is further known to produce the supports out of composite reinforced concrete and to equip them with the pieces of equipment made of steel while they are being produced. In this process, to improve their stability, these pieces of equipment can be connected via welding to a rigid framework, at least part of which lies in concrete, and/or to a form capable of being used during casting (DE 42 19 200 A1, EP 0 381 136 B1). Methods of this type require pieces of equipment and functional areas which have been produced with high precision, however, which is why said methods have not yet been used in practice.

The same applies for numerous other methods known for the production and installation of pieces of equipment, based on the idea of producing structural units provided with all necessary functional surfaces and prefabricated entirely separately from the carriers. Said structural units are fixed to the associated carriers at the construction site with the aid of adjustable screws or the like (DE 41 15 935 A1, DE 41 15 936 A1, DE 196 19 866 A1, DE 196 19 867 A1). Narrow tolerances can be adhered to in this case as well only if the prefabricated structural units have already been produced with the required accuracy. As a result, no advantages are obtained as compared with the other methods stated, since the alignment problem is simply shifted from the carriers to the structural units.

To lessen the problems described, it is furthermore already known to use—instead of the structural units extending along the entire length of the track-only short, e.g., 6 m—long, driveway plates of the general class described initially, i.e., plate-like modules. These modules are produced, e.g., entirely of steel via welding or with a sandwich structure, by inserting laterally guiding rails, slide rails and stator carriers in a steel form in a custom-fit manner before casting the concrete. The purpose of modules of this type is to prevent the need to subsequently adjust the positions of the various functional areas relative to each other. In addition, the production of short, plate-like and identically configured modules should allow them to be placed along polygon outlines—similarly to the stator cores—thereby allowing a predefined space curve to be approximated (DE 198 08 622 C2, DE 298 09 580 U1, EP 1 048 784 A2). To fix the plate modules to the carriers, it is proposed, among other things, to provide holding devices and/or spacers which are attached to the undersides of modules which extend into openings of the supports and are configured such that they either form a fixed bearing or provide the module with a degree of freedom. It is also provided to realize the necessary curve banks and/or lateral inclinations of the driveway by inserting suitable wedge pieces and spacers between the modules and carriers.

One problem with a modular construction of this type is that the required narrow tolerances can be realized, at best, if it is used to produce straight driveway segments or driveway segments which are bent with very large radii in the three spacial directions. The reason for this is that, the smaller the radii of the curves, the more noticeable are the results of a polygonal displacement of individual modules, in particular with regard for exact tracking and the objective thereof, i.e., driving comfort.

Despite the related art explained above, the driveways, driveway modules and methods for their production which are therefore known to date are not satisfactory in every aspect.

Based thereon, the present invention is based on the technical problem of configuring the driveway of the general class such that it has the required dimensional consistency along its entire length, without the pieces of equipment needing to be oriented using laborious measures. In addition, a driveway module and a method for its production are proposed, by means of which the installation of a driveway for magnetically levitated vehicles is greatly simplified, yet still ensures adherence to the tolerances stated.

The characterizing features of Claims 1, 18 and 21 serve to achieve this means of attaining the object of the present invention.

Further advantageous features of the invention result from the subclaims.

The present invention is explained in greater detail with reference to exemplary embodiments in combination with the attached drawings.

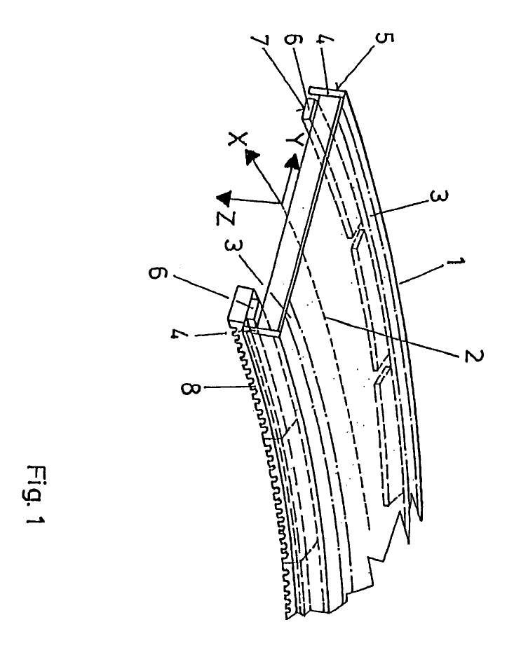

FIG. 1 shows the perspective view of an idealized driveway module with the usual laterally guiding surfaces, gliding surfaces and stator core mounting surfaces in the region of a driveway segment extending around a curve;

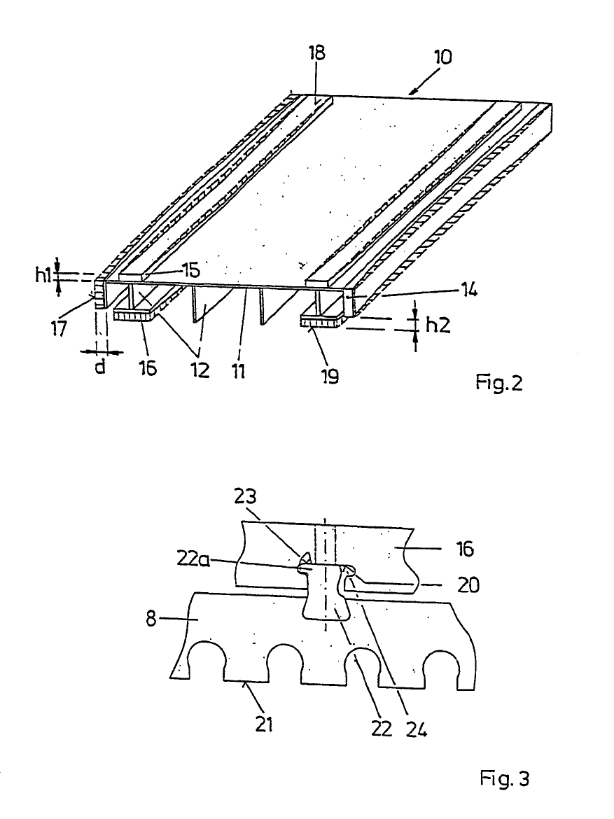

FIG. 2 is the perspective depiction of a driveway module produced in accordance with the invention;

FIG. 3 shows, in a greatly enlarged, schematic depiction, the fixing of a stator core to a mounting surface of the module according to FIG. 2;

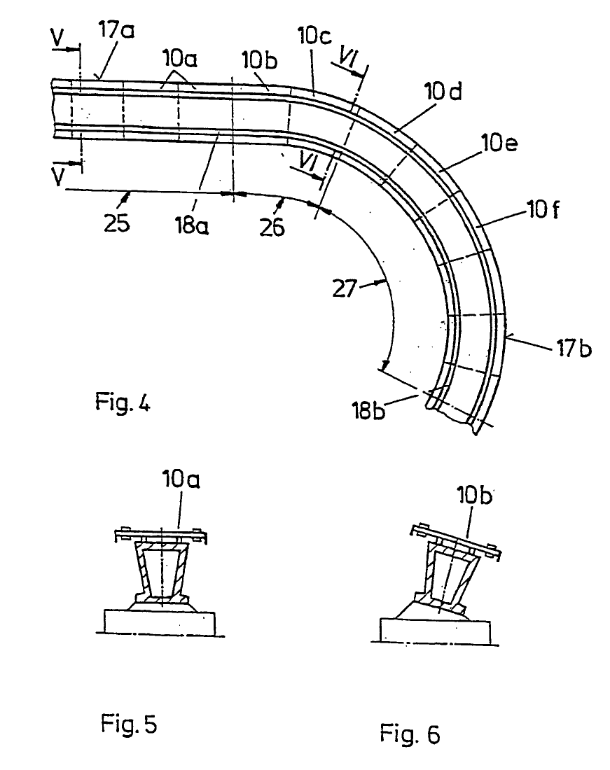

FIG. 4 is a schematic top view of a driveway produced in accordance with the present invention, out of modules according to FIG. 2;

FIGS. 5 and 6 show sections along the lines V-V and VI-VI in FIG. 4;

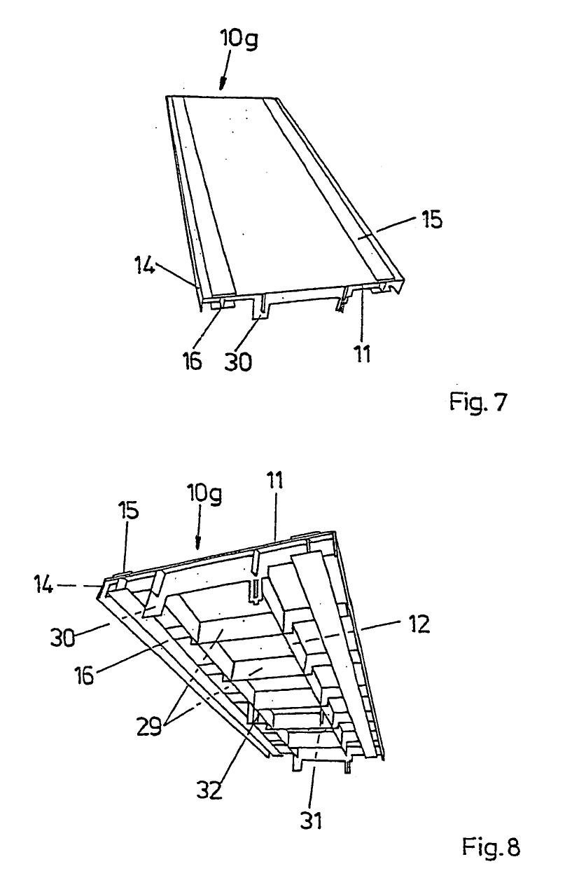

FIG. 7 is a perspective top view of a further exemplary embodiment of a module according to the present invention in a non-jointly-carrying construction;

FIG. 8 is a perspective underside view of the module according to FIG. 7;

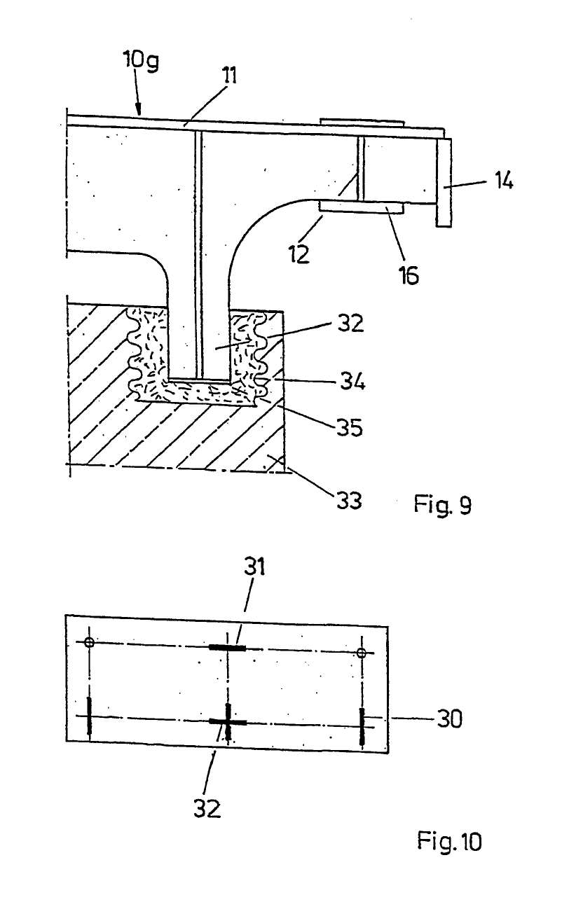

FIG. 9 shows, schematically, the installation of the module according to FIGS. 7 and 8 on a concrete support;

FIG. 10 is a schematic depiction of a bearing scheme for the module according to FIGS. 7 through 9;

FIG. 11 shows a schematic depiction of a further exemplary embodiment for the installation of a module according to the present invention in a non-jointly-carrying construction;

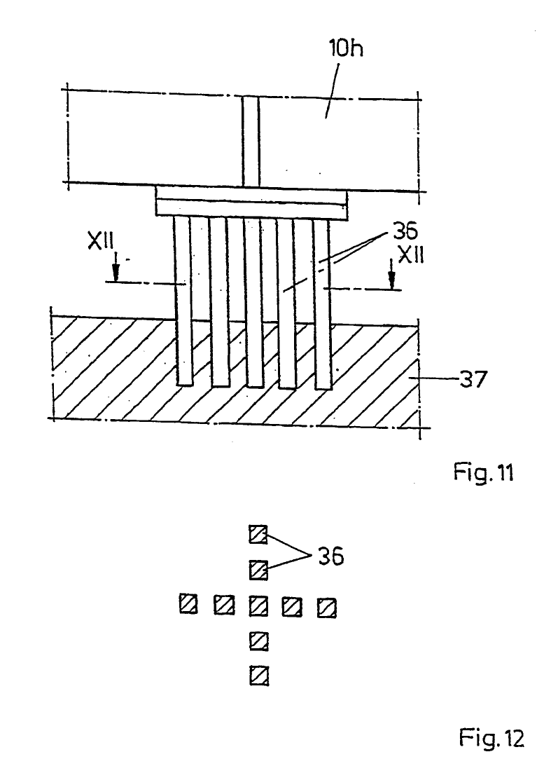

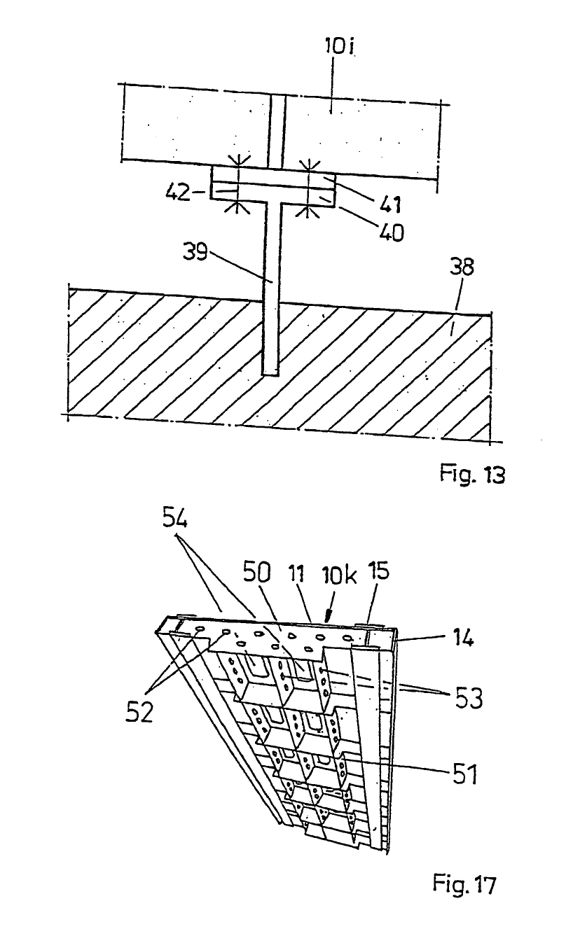

FIG. 12 shows a cross section along the line XII-XII in FIG. 11;

FIG. 13 is a schematic depiction of a third exemplary embodiment for the installation of a module according to the present invention in a non-jointly-carrying construction;

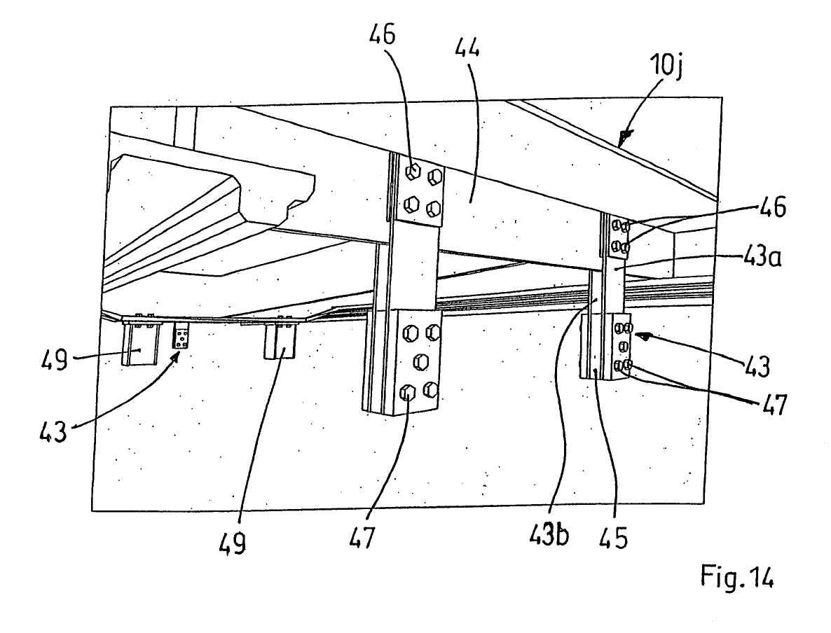

FIGS. 14 through 16 show a schematic depiction of a section of a fourth exemplary embodiment for the installation of a module according to the invention in a non-jointly-carrying construction, in a perspective view, and as a cross section and a longitudinal section through a bearing; and

FIG. 17 is a schematic depiction of an underside view, in accordance with FIG. 8, of a module according to the present invention in a jointly-carrying construction.

FIG. 1 shows a driveway module 1 made of steel and depicted in an idealized manner, which is suitable for building a driveway for a magnetic levitation track with a longitudinal stator linear motor. In the exemplary embodiment, there is a module 1, which is bent in entirety in a longitudinal manner along a predetermined track, as indicated by a space curve 2 depicted in its center plane. An axis system is also depicted schematically, with x, y and z axes, which are perpendicular to each other. A bend around the x axis represents a lateral inclination in the sense of a curve bank, a bend around the y axis represents a section of the driveway which is passing over a summit or through a valley, and a bend around the z axis represents driving around a curve.

On its top side, module 1 has two parallel, essentially horizontally positioned segments which function as gliding surfaces 3 and, on its longitudinal sides, it has two essentially vertical laterally guiding rails 4, which are equipped on their outsides with laterally guiding surfaces 5. In addition, two essentially horizontal stator carriers 6 are located on the underside of module 1, the stator carriers being provided on their undersides with mounting surfaces 7 (shown on the left in FIG. 1) for stator cores 8 (shown on the right in FIG. 1). With regard for the rest, module 1 is mounted on a carrier, which is not shown.

Module 1, shown in FIG. 1 and adapted overall to the course of the track, would have the advantage that nearly ideal driving properties would result. The disadvantage, however, would be that each individual module 1 would have to be adapted to the bends existing at the site where it is installed in the driveway; this would be very complex in terms of production. A driveway produced with modules 1 of this type has therefore not yet been made known. It is more common to configure all modules 1 identically and provide them with flat gliding surfaces 3, laterally guiding surfaces 5 and mounting surfaces 7 within the framework of production tolerances (e.g., DE 198 08 622 C2, EP 1 048 784 A2).

In the region of curves or the like, these modules 1 are installed in the manner of a polygon outline which approximates space curve 2. If the length of a module 1 is approximately 6 m, then five modules 1 of this type can be positioned one behind the other in a polygonal manner on a carrier which is approximately 30 m long. A polygonal arrangement of modules 1 for magnetically levitated vehicles operated at speeds of 500 km/h and higher is reasonable only when driveway sections are used which are straight or are bent with very large radii of curvature. On the other hand, noticeable deteriorations result with smaller radii of curvature starting at approximately 2000 m and lower, which impair driving comfort and have been tolerated so far.

In contrast, it is proposed according to the present invention to provide driveway modules 10 in accordance with FIG. 2. A driveway module 1 of this type, which is plate-like overall, is essentially composed of a relatively thin, plane-parallel cover plate 11 made of steel, on the underside of which perpendicularly projecting segments 12 are fixed, preferably by welding, the segments functioning as braces. Common laterally guiding rails 14 extending in the x direction are installed on the lateral longitudinal edges of cover plate 11. Two side rails 15, which also extend in the x direction, are mounted on the top side of cover plate 11. Finally, web-like stator carriers 16 are fixed to the undersides of two segments 12 transversely to said segments.

The components described are all preferably composed of steel and are connected together by welding to form one continuous component. In addition, all driveway modules 10 are preferably produced in an identical manner, whereby laterally guiding rails 14 and slide rails 15, which are referred to generally as first pieces of equipment, and stator carriers 16, which are referred to as the second pieces of equipment, all have an uninterrupted straight configuration and are composed, e.g., of essentially plane-parallel profiles.

In their finished state, pieces of equipment 14, 15 and 16 have the first functional surfaces explained with reference to FIG. 1 on their outer, top and undersides in the form of laterally guiding surfaces 17 and gliding surfaces 18, and second functional surfaces in the form of mounting surfaces 19. These functional surfaces 17, 18 and 19 are produced, according to the present invention, by producing all pieces of equipment 14, 15 and 16 with sufficient oversize and then machining them down in a cutting manner to a predefined setpoint dimension. This is indicated in FIG. 2 by the shaded regions of the pieces of equipment, which represent the overmeasure of material. As indicated in FIG. 2, laterally guiding rails 14 are machined down to a final dimension d, slide rails 15 are machined down to a final dimension h1, and stator carriers 16 are machined down to a final dimension h2. To make this possible, the oversize and/or original thickness of laterally guiding rails 14 is selected such that, after module 10 is produced, the outer surfaces of laterally guiding rails 14 have a greater distance from each other overall than the required track width. Accordingly, the machining allowances and/or the heights of slide rails 15 and stator carriers 16 are selected to be so great that, after production of module 10, the top sides of slide rails 15 and/or the undersides of stator carriers 16 have a greater distance from each other overall than the required dimension of the binding piece.

Module 10 is completed in a working step which follows the welding work, in the form of machining down the oversized surfaces in a cutting manner. This machining work is carried out preferably by milling, although it could also be replaced with planing or any other suitable type of machining. The procedure is as follows, for example:

For modules 10 coming out of production, a fictitious center axis and/or axis of symmetry extending parallel to the x axis is first established, with consideration for the individual machining allowance. In the extreme case, this fictitious center axis can deviate from the actual (geometric) component axis by a few millimeters to both sides, e.g., because laterally guiding rails 14 or slide rails 15 were not fixed exactly.

Laterally guiding rails 14 are now machined down on their outsides in a cutting manner in the y direction, and side rails 15 are machined down on their top sides in a cutting manner in the z direction, to obtain laterally guiding surfaces 17 and gliding surfaces 18 according to FIG. 2. It should be noted that laterally guiding surfaces 17 and gliding surfaces 18 do not require exact positioning in the z and y directions, respectively; their position is therefore not critical in this regard.

An advantage of the method described is that the laterally guiding surfaces 17 and gliding surfaces 18 can be machined using the same work mounting, e.g., in a portal milling machine, e.g., by first using a face cutter in the vertical position to make laterally guiding surfaces 17 and then in a horizontal position, pivoted by 90°, to make gliding surfaces 18, and then moving it once to the left and once to the right of the fictitious center axis.

The machining of laterally guiding rails 14 and slide rails 15 carried out in the individual case depends on whether module 10 is intended for straight driving or for driving around a curve, up a hill or into a valley, or the like. For a module 10 intended for a straight driveway section, the finished laterally guiding and gliding surfaces 14, 15 are each produced as planes extending parallel to the xz and/or xy plane. If modules 10 are intended for a bent driveway section similar to FIG. 1, however, then laterally guiding rails 14 and gliding surfaces 15 are machined such that laterally guiding surfaces 17 and gliding surfaces 18 take on a bend that corresponds exactly to the particular associated section of the space curve (e.g., 2 in FIG. 1). In this case, the milling procedure is carried out with a computer-aided tool, using all necessary track-related data. As a result, despite the fact that modules 10 and pieces of equipment 14, 15 and 16 were originally configured straight in shape, laterally guiding surfaces 17 and gliding surfaces 18 according to FIG. 2 have exactly the same bends after machining which were referred to as being ideal for laterally guiding surfaces 5 and gliding surfaces 3 shown there, since they follow the course of the track exactly. As a result of the present invention, the advantage therefore results that, with the aid of a milling procedure which is relatively easy to carry out, laterally guiding surfaces 17 and gliding surfaces 18 can be configured such that they are not exactly parallel to each other, and, instead, due to the selected machining allowances, they can be adapted in an optimum manner to the course of the track, even over the entire length of the course. The resultant tolerance deviations are much smaller than those that would result with the polygonal placement of identically configured, straight modules. In addition, the expenditure required to produce modules 10 is substantially less than if laterally guiding rails 14 and slide rails 15 would have to be adjusted as they were previously by orienting them to the associated space curve sections, or if the modules would have to be bent individually, similar to FIG. 1 as a whole.

The fixing of stator cores 8 to stator carriers 16 can take place in various manners that are known per se (e.g., DE 34 04 061 C2, DE 39 28 278 C2). In the exemplary embodiment, the fixing means shown in FIG. 3 are provided, in analogy to DE 39 28 278 C2. To do this, mounting surfaces 19 are configured on the undersides of stator carriers 16 (FIG. 2) as first contact surfaces 20 (FIG. 3). Said contact surfaces 20 must be produced in a precise manner and positioned as parallel as possible with gliding surfaces 18 (FIG. 2), since they determine the exact position of stator cores 8 on modules 10. They must also have a predefined distance from gliding surfaces 18 in the z direction, which serves to establish a predefined dimension of the binding piece, the dimension of the binding piece corresponding, in the installed state, to the distance of gliding surfaces 18 from undersides 21 of stator cores 8 and establishing, among other things, the dimension by which the vehicles must be lifted from a standstill to the levitated state. In addition, undersides 21 interact with the bearing and excitation magnets of the vehicles in a known manner, and a gap is formed between them.

Stator cores 8 are connected at their top sides with traverses 22 in a fixed manner, the traverses extending transversely to the longitudinal directions of said stator cores and/or in the y direction, and having projections 22a with dovetail or T-type cross sections projecting over stator cores 8 and also extending in the y direction. The top sides of these projections 22a are configured as second contact surfaces 23 (FIG. 3), which extend exactly parallel to and with constant distances from undersides 21.

Projections 22a are used to produce a redundant, detachable connection with modules 10 in grooves 24 (FIG. 3), which are configured in the undersides of stator carrier 16, have dovetail or T-type cross sections which essentially correspond to the cross sections of projections 22a and are positioned essentially parallel to the y direction of modules 10. The bottoms of these grooves 24 form contact surfaces 20, the bottoms interacting with contact surfaces 23 and establishing the position and orientation of stator cores 8 and/or undersides 21.

After production of laterally guiding surfaces 17 and gliding surfaces 18 as described above, vehicle modules 10 are mounted in a boring and milling machine and/or grooving cutter, depending on the configuration of contact surfaces 20, 23, to form—in a manner known per se—grooves 24, contact surfaces 20 and the bore holes for the fastening screws in stator carriers 16. The extension of contact surfaces 20 in the y direction is not a critical factor, and there are as many first contact surfaces 20 in the x direction at predefined distances as there are traverses 22 mounted on stator cores 8. Stator carriers 16 can have lengths which correspond to stator cores or modules 10, or they can be composed of individual components separated by a distance corresponding to grooves 24.

In contrast to laterally guiding surfaces 17 and gliding surfaces 18, all contact surfaces 20 associated with a certain stator core 8 each lie in a plane. As long as the driveway segments are straight, contact surfaces 20 of all associated stator cores 8 lie in the same (xy) plane. If the driveway segments are bent, however, then contact surfaces 20 each lie in planes which deviate from each other such that their polygonal arrangement described above results automatically after stator cores 8 are installed.

Stator cores 8 are fixed to stator carriers 16 after projections 22a are inserted in grooves 24 with the aid of fastening screws (shown only schematically) which pass through traverses 22, whereby the cross sections of projections 22a and grooves 24 described ensure that, if any of these fastening screws should eventually undergo fatigue fracture, the associated stator core 8 will not fall out. For this purpose, projections 22a can also be positioned in grooves 24 with slight play, as shown in FIG. 3 in particular. Only in the state in which stator cores 8 are installed using the fastening screws, are contact surfaces 20, 23 then in diametrically opposed positions, while, if there are no fastening screws between contact surfaces 20, 23, a small gap is produced, which can be detected using sensors carried on the vehicles and used to detect a broken screw.

FIGS. 4 through 6 show a longer section of a driveway produced using one of the driveway modules 10 according to the present invention. A transitional section 26 with two modules 10b, 10c abut a straight driveway section 25 with a plurality of straight modules 10a determined for driving straight ahead, the two modules forming a transition from straight driveway section 25 to a curved section 27, which is bent with a relatively small radius of curvature and contains a plurality of modules 10d, 10e and 10f, etc. To produce this driveway, driveway modules 10a are produced in a completely straight configuration and are provided with flat laterally guiding surfaces 17a and gliding surfaces 18a. Modules 10d, 10e and 10f, etc. are also produced in a completely straight configuration, in a manner explained with reference to FIGS. 2 and 3, but they are then provided with laterally guiding surfaces 17b and gliding surfaces 18b, which are bent in all three directions (FIG. 1).

In principle, driveway modules 10b, 10c in transitional section 26 could be configured analogously to those in curve section 27. According to the present invention, however, a production technique which is modified compared to FIG. 2 is used for these modules 10b, 10c. It is thereby assumed that the bends in transitional section 26 still extend along radii that are so great that a polygon-like arrangement of completely straight modules 10b, 10c corresponding to modules 10a would suffice, in principle. Since a relatively great lateral inclination (maximum of approximately 160) of modules 10d, 10c, 10f, etc. is required in curve section 27, however, even given a polygonal arrangement, this could result in an undesirably large lateral and level displacement at the junctions of the right or left laterally guiding surfaces 17 and gliding surfaces 18, as indicated by the different lateral inclinations in FIGS. 5 and 6. To prevent this, it is proposed according to the present invention to elastically twist modules 10b, 10c gradually around their longitudinal axis and/or the x axis, and to elastically twist them in a translational manner in the x direction (driving direction), and to fix them, in this twisted form, to associated supports 28 shown in FIG. 6. The dimension of twisting is thereby preferably selected such that the junction surface of module 10b shown on the left in FIG. 4 is exactly flush with the right junction surface of adjacent module 10a and, accordingly, the right junction surface of module 10c is exactly flush with the adjacent junction surface of module 10d, i.e., a corresponding gradual change in the lateral inclination is obtained within each module 10b, 10c. The same applies for the junction between modules 10b and 10c, so that no disturbing lateral or level displacement occurs anywhere in transitional section 26.

The twisting of modules 10b, 10c can be carried out, e.g., before they are fixed to the associated support using grouting compound or the like with the aid of an installation frame carried on an installation vehicle, or simply by fixing them to the associated support in the region of their end faces with the aid of screw joints which can be adjusted in the z direction. To enable a twisting of this type, modules 10b, 10c are configured either with sufficient flexibility, e.g., by eliminating stiffening bulkheads and other transverse connections, or by producing them in entirety out of a relatively soft material. Since the twisting is required for the rest only over a dimension of a few millimeters, they do not cause any problems with modules having a length of up to approximately 6 m, either. Regardless of this, it is clear that the size of the bends shown in FIG. 4 is exaggerated, and the non-visible parts of the modules are essentially straight and identical.

FIGS. 7 and 8 show details of a module 10g according to the invention from above and below analogously to FIG. 2, although in the state in which the various pieces of equipment have not yet been machined. In FIG. 8 in particular, it is shown that projecting segments 12 can be connected by bulkheads 29, to obtain a deflection-resistant overall construction with cover plates 11. Cover plates 11, projecting segments 12 and bulkheads 29 are advantageously connected by welding.

Module 10g according to FIGS. 7 and 8 is configured as a “nonjointly-carrying” component and, according to the present invention, is provided with an integral bearing. This means that the forces exerted on module 10g are introduced directly into the carrier located underneath, but adjacent modules 10g are not connected with each other in the x direction in a non-shear-resistant manner. Bar-shaped or web-like bearing elements which are resilient at least in a predetermined direction are preferably used here as integral bearings. As shown in FIG. 8 in particular, web-like elements 30 are provided, e.g., in the region of the front and rear end faces, which are resilient in the x direction (FIG. 1), but are essentially deflection-resistant in the y direction. On the other hand, web-like bearing elements 31 are installed in the region of the lateral edges, the bearing elements being resilient only in the y direction, but not in the x direction. Bearing elements 30, 31 therefore fulfill the function of a floating bearing, each of which is resilient in one direction. Finally, a fixed bearing can advantageously be provided in a center region of module 10g by combining one each of bearing elements 30, 31 to form a bearing element 32 having a cruciform cross section (refer also to FIG. 10). Bearing sheets with correspondingly reduced flexural stiffness are suitable for use as materials for bearing elements 30, 31 and 32, or, with particular advantage, spring sheets, i.e., sheet-metal strips made of spring steel.

Module 10g can be installed on primary support 33 made of concrete in accordance with FIG. 9 by providing corresponding recesses 34 in said primary support on its top side and at those points where bearing elements 30, 31 and 32 come to rest, the recesses accommodating part of bearing elements 30, 31 and 32 and, after module 10 g is oriented on support 33, they are filled with (secondary) mortar 35. The entire module 10 g is then positioned, using bearing elements 30, 31 and 32 at a predefined distance of, e.g., approximately 200 mm above the support surface, whereby bearing elements 30 function as fixed bearings in the transverse (y) direction, bearing elements 31 function as fixed bearings in the longitudinal (x) direction, and bearing elements 32 function as fixed bearings in the longitudinal and transverse direction. An exemplary arrangement of the bearing elements on module 10 g results as shown in FIG. 10, where the effect of the various bearing elements is indicated by bold lines. The circles indicate that bearing elements that are flexible in all directions, i.e., floating bearing elements, are provided there.

An alternative exemplary embodiment of the present invention for the bearing elements is shown in FIGS. 11 and 12. Instead of web-like bearing elements, bar-shaped bearing elements 36 are provided here in the form of bars having a square cross section. Bearing elements 36 are installed on the undersides of modules 10a in a cruciform pattern shown in FIG. 12 and are fixed to a support 37 in a not-shown manner (e.g., analogously to FIG. 9). Bearing elements 36 are composed, e.g., of flexural bars that are flexible at least in the x and y direction and, when circular cross sections are used, said flexural bars are flexible in practically all directions transverse to their longitudinal axes. They therefore essentially fulfill the task of floating bearings, which can absorb forces in a plurality of directions, e.g., as is the case when temperature fluctuations occur. Floating bearings of this type can be provided at the points marked with circles in FIG. 10, for example. The number of bearing elements 36 that are used at each bearing site depends in particular on the materials selected and the desired distance of modules 10h from supports 37.

FIG. 13 shows a further exemplary embodiment for fixing modules 10i to a support 38. With this variant, bearing elements 39 are fixed to the top sides of support 38 in a fixed manner, in accordance with FIGS. 7 through 12, and they are provided with connecting flanges 40 on their top ends. On the other hand, corresponding connecting flanges 14 located at the particular fixing points are fixed, e.g., by welding, to the undersides of modules 10i. It is then necessary only to place modules 10i with their flanges 41 on flange 40 and then connect the two using fastening screws 42 passing through flange 40, 41. The advantage of this is that modules 10i are detachably connected with supports 38 and can be easily removed and replaced, if necessary. In addition, compared to FIGS. 9 and 11, this variant offers the advantage that, by inserting shims between flanges 40, 41, it is easy to align individual modules 10i with the track and, in the region of the junctions, to orient them on supports 38 without displacement. Bearing elements 39 can be configured analogously to FIGS. 7 through 12.

A further exemplary embodiment for a non-jointly-carrying component, which has been considered to be the best so far, is shown in FIGS. 14 through 16. Bearing elements 30 according to FIGS. 7 and 8 are each replaced in this case with pairs 43 of two web-like bearing elements 43a, 43b oriented parallel to each other, in the manner of leaf springs. Similar to the exemplary embodiments according to FIGS. 11 and 13, bearing elements 43a, 43b of modules 10j are separate components which are resilient in the x direction (refer also to FIG. 1). As shown in FIGS. 14 through 16 in particular, the underside of module 10j is provided on its front and rear end faces with short mounting strips 44 in the form of plane-parallel projections or projecting segments, the planar surfaces of which extend perpendicularly to the x direction. The upper ends of the two bearing elements 43a, 43b of pair 43 bear against both planar surfaces of mounting strips 44, so that the broad sides of bearing elements 43a, 43b also stand perpendicularly to the x direction. The lower ends of bearing elements 43a, 43b are held together by spacers 45 located between them. Fastening screws 46 and 47 are used to fix bearing elements 43a, 43b in place, the fastening screws being projecting through coaxially orientable holes in mounting strips 44, spacers 45 and bearing elements 43a, 43b, and bolts screwed onto fastening screws 46, 47. Other fastening elements can also be used as an alternative.

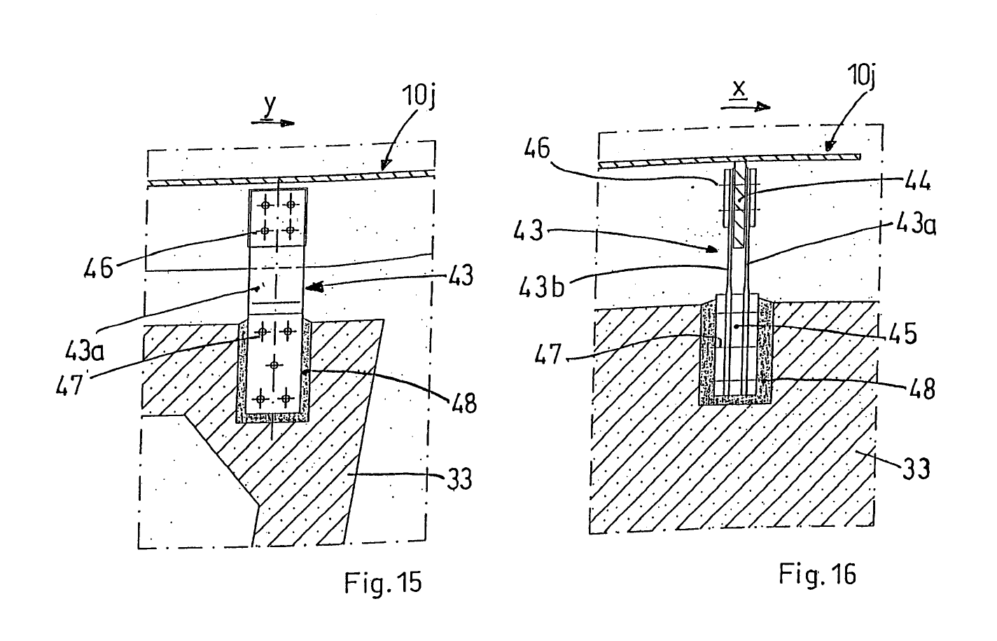

As shown in FIGS. 15 and 16, modules 10j are mounted on supports 33 after installing bearing elements 43a, 43b and spacers 45 in a manner analogous to FIG. 9, for example, using secondary mortar 48.

In addition, plate-like spacers and/or spacer sheets are preferably located beween mounting strips 44 and bearing elements 43a, 43b. They serve the purpose of permitting springy motions of bearing elements 43a, 43b without impacting mounting strips 44, and/or without permitting deflections around their lower ends. On the other hand, relatively short spacers can enlarge the lever arms of bearing elements 43a, 43b, which improves the spring properties.

With the exemplary embodiment according to FIGS. 14 through 16, as shown in FIG. 14 in particular, two pair 43 of bearing elements 43a, 43b are provided in both the front and rear regions of module 11j; they are resilient in the x direction, but not in the y direction, and, like bearing elements 30, perform the function of floating bearings. Two or more further bearing elements 49 provided in a central region of module 10j preferably also represent separate components which can be joined with module 10j using screws. Said further bearing elements are configured as fixed bearings, however, which fulfill the function of fixed bearing 32 in FIGS. 8 through 10, for example.

An essential advantage of the exemplary embodiment according to FIGS. 14 through 16 is that modules 10j and bearing elements 49 can be produced out of material which is sufficiently rigid for static purposes, but spring elements 43a, 43b can be produced out of a material such as spring steel, for instance, which allows temperature expansions and contractions to occur. A further advantage resulting therefrom as compared with the exemplary embodiment according to FIGS. 7 thorugh 10 is that bearing elements which are shorter in the z direction can be realized and, therefore, lower installation heights of modules 10j above support 33. Finally, an essential advantage is that high redundancy results due to the use of bearing elements 43a, 43b in pairs. Even if one bearing element in a pair fractures, adequate carrying capacity still remains for emergency operation.

Floating bearings which are effective in the y direction are not provided with the exemplary embodiment according to FIGS. 14 through 16. They can be eliminated if the expected temperature expansions and/or contractions are relatively small due to small module widths of 1 m, for example. It is also clear that, instead of using bearing elements and/or leaf springs 43a, 43b in pairs, it is also possible to use only one bearing element each or to provide more than two bearing elements per bearing site.

Finally, FIG. 17 shows an exemplary embodiment of the present invention for a module 10k in the form of a “jointly-carrying” component, i.e., a component which is connected with the associated carrier and with corresponding modules 10k of the same carrier in front of or behind said carrier in the x direction. In this case, bearing elements 30, 31, 32, 36, 39 and 43 are replaced with relatively stiff strips and/or projecting segments 50 and 51 projecting downward from the underside of modules 10k and extending in the transverse and longitudinal direction, in which holes 52, 53 are configured. Depending on the type of carriers used, these holes 52, 53 can be used to accommodate screws or plugs, to fix abutting modules 10k to each other or to the associated carriers, or they can be used as through holes for concrete or reinforcing rods and extend into corresponding recesses of a concrete carrier. In the latter case, modules 10k are also preferably provided with through holes 54 configured in cover plates 11, which can be used as openings for pouring concrete or enabling secondary mortar to flow into the recesses in the carrier. Instead of projecting segments 50, 51, other shear connecting means can also be provided, in the form of cap plugs or the like.

All of the exemplary embodiments described enable prefabrication of modules 10 via welding or any other method, followed by a positionally accurate configuration of the individual functional surfaces 17, 18 and 19 by machining them down in a cutting manner, in particular via milling. As a result, a displacement of functional surfaces 17, 18 and 19 caused by welding or alignment work to be carried out subsequently is prevented, which said displacement would make it necessary to perform machining once more and/or to make a fine-tuning adjustment. The advantage also results that modules 10 can be configured in series production and identically, since the final shaping of the laterally guiding surfaces 17, gliding surfaces 18 and mounting surfaces 19 must be carried out subsequently. It is clear that the particular machining allowance on the associated functional components 14, 15 and 16 is advantageously selected to be greater than the greatest material thickness to be machined down in a cutting manner which will become necessary within a projected driving route. Previously, the following values have proven adequate for the machining allowance: values of approximately 8 to 10 mm for laterally guiding surfaces 14, with a thickness of the laterally guiding rails 14 of approximately 30 mm, and values of approximately 5 mm for the slide rails 15 and stator carriers 16. It is also clear that more rigid modules can be provided for driveway section 25 in FIG. 4 than for driveway section 26. For the rest, an essential difference in the production of the first and second functional surfaces 17, 18 and/or 19 is that second functional surfaces 19 are used only for the installation of stator cores 8, which are important for driving behavior, while first functional surfaces 17, 18 directly influence on driving comfort.

According to a particularly preferred exemplary embodiment of the present invention, slide rails 15 are made of stainless steel or weather-proof steel. This results in the advantage that, in case of an emergency shutdown of the vehicles, when the undercarriage skid of the vehicle is lowered onto slide rails 15 for other reasons, or, e.g., when clearing away snow using a snow-plowing vehicle which has a scraping shield lying on slide rails 15, there is no risk of that an insulation layer that may be provided on slide rails 15 will be damaged or scraped away entirely. An insulation layer of this type is usually provided in addition to all three functional surfaces 17, 18 and 19 and contact surfaces 20, for corrosion protection in particular, and is normally relative thin, e.g., with a thickness of 0.5 mm. When slide rails 15 made of stainless steel or weather-resistant steel are used, the insulation layer can be eliminated.

The present invention is not limited to the exemplary embodiments described, which could be modified in numerous ways. This applies, in particular, for the number and arrangement of laterally guiding rails 14 and slide rails 15 used in the individual case. Depending on the type of magnetically levitated vehicles, it can be sufficient, for example, to provide only one single slide rail 15 and laterally guiding rail 14 in a center region of modules 10, whereby these laterally guiding rails 14 could be provided with laterally guiding surfaces on both sides of an imaginary center axis. Accordingly, only one single linear motor could be used for propulsion. In this case, it would be sufficient to provide the modules with only one row of stator carriers 16 extending in the longitudinal direction, and grooves 24 and/or contact surfaces 20 configured in said stator carriers. Furthermore, the length of modules 10 can be varied, and they can be only approximately 2 m long, instead of approximately 6 m long. The various bearing elements described with reference to FIGS. 7 through 16 serve as examples only, which could be replaced with other bearing elements if necessary and if it were advantageous to do so. The shape and configuration of modules 10 overall was indicated for example purposes only. It would also be possible, for example, to connect pieces of equipment 14, 15 and 16 via welding to a rigid frame and to then cast them with concrete in a manner known per se. Following this, the various pieces of equipment could be machined down in a cutting manner as described. It is furthermore clear that the various bearings (FIGS. 7 through 17) are also advantageously usable independently of the special modules according to FIGS. 1 through 6. Finally, it is understood that the various features can also be used in combinations other than those described and presented here.

What is claimed is:

1. A driveway for magnetically levitated vehicles with at least one carrier and a plurality of driveway modules (10) situated along a track and fixed to said carrier, the modules comprising first functional surfaces (17, 18) in the form of at least one laterally guiding surface and one gliding surface, and two functional surfaces (19) in the form of stator core mounting surfaces, wherein the first and second functional surfaces (17, 18, 19) are embodied on oversized pieces of equipment (14, 15, 16) which are made of steel, are connected in a fixed manner to the module (10), and are machined down in a cutting manner to a predefined setpoint dimension (d, h1, h2).

2. The driveway as recited in claim 1, wherein the modules (10) and pieces of equipment (14, 15, 16) are made of steel and are joined by welding.

3. The driveway as recited in claim 1, wherein the pieces of equipment (14) for the laterally guiding surfaces (17) are composed of laterally guiding rails.

4. The driveway as recited in claim 1, wherein the pieces of equipment (15) for the gliding surfaces (18) are composed of slide rails fixed to the top sides of the modules (10).

5. The driveway as recited in claim 1, wherein the slide rails (15) are made of stainless steel or weather-resistant steel.

6. The driveway as recited in claim 1, wherein the modules (10) have a plate-like configuration.

7. The driveway as recited in claim 1, wherein the pieces of equipment (16) for the mounting surfaces (19) are composed of stator carriers fixed to the undersides of the modules (10).

8. The driveway as recited in claim 1, wherein the laterally guiding and/or gliding surfaces (17, 18) are bent in the region of curves along space curves (2) predetermined by the track.

9. The driveway as recited in claim 1, wherein the modules (10k) are configured as jointly-carrying components.

10. The driveway as recited in claim 9, wherein the carriers are made of concrete, and modules (10k) are fixed to the carriers via casting.

11. The driveway as recited in claim 10, wherein the modules (10j) are provided with concrete-casting openings (54) in the region of cover plates (11).

12. The driveway as recited in claim 10, wherein the modules (10k) are provided with shear connecting means (50, 51) located underneath.

13. The driveway as recited in claim 9, wherein the supports are made of steel, and the modules (10k) are fixed to the carriers via screwing or welding.

14. The driveway as recited in claim 1, wherein the modules (10g through 10j) are configured as non-jointly-carrying components.

15. The driveway as recited in claim 14, wherein the carriers (33) are made of concrete, and the modules (10g) are provided with integral bearing elements (30, 31, 32) on their undersides, the bearing elements being bendable in the longitudinal and/or transverse direction and being fixed to the carriers (33) via casting.

16. The driveway as recited in claim 15, wherein the modules (10g) are provided with at least one bearing element (32) intended for forming a fixed bearing.

17. The driveway as recited in claim 15, wherein the bearing elements (36, 39, 43a, 43b, 49) are joined with the modules (10h through 10j) in a detachable manner.

18. The driveway as recited in claim 1, wherein the modules (10b, 10c) are twisted in an elastic manner in transition regions from straight sections to curves and vice-versa to account for changes in the lateral inclination, and they are fixed to the carriers (28) in the twisted state.

19. A driveway module for magnetically levitated vehicles with functional surfaces (17, 18, 19) in the form of at least one laterally guiding surface, one gliding surface, and one stator core mounting surface, wherein all functional surfaces (17, 18, 19) are embodied on oversized pieces of equipment (14, 15, 16) which are made of steel, are connected in a fixed manner to said module, and are machined down in a cutting manner to a predefined setpoint dimension (d, h1, h2).

20. The driveway module as recited in claim 18, wherein it is also configured as recited in claim 2.

21. The driveway module as recited in claim 19, wherein it is configured in an elastically twistable manner to produce changes in the lateral direction.

22. A method for producing a driveway module (10) as recited in claim 19, wherein the module (10) is produced with the tolerances typical for steel construction, and the pieces of equipment (14, 15, 16) are produced at least with an oversized dimension which is adequate for typical driveways, and wherein the pieces of equipment (14, 15, 16) are then provided—by machining them down in a cutting manner, and with the tolerances required by the driving properties—with functional surfaces (17, 18, 19) that are straight and/or bent in a manner predetermined by the track.

23. The method as recited in claim 22, wherein the module (10) and pieces of equipment (14, 15, 16) are produced separately with the tolerances which are typical for steel construction, and are then joined via welding.

24. The method as recited in claim 23, wherein the machining down in a cutting manner is not carried out until all of the welding work relevant for the positional accuracy of the functional surfaces is completed.

25. The method as recited in claim 22, wherein the machining down in a cutting manner is carried out via milling.

26. The method as recited in claim 22, wherein the modules (10b, 10c) are twisted in an elastic manner to produce changes in the lateral inclination, and are fixed to the supports (28) in the twisted state.
